(19) United States
(12) Patent Application Publication
(10) Pub. No.: US 2025/0189719 A1
(43) Pub. Date: Jun. 12, 2025

(54) DETECTION DEVICE

(71) Applicant: Japan Display Inc., Tokyo (JP)

(72) Inventor: Tomoyuki ISHIHARA, Tokyo (JP)

(21) Appl. No.: 18/962,781

(22) Filed: Nov. 27, 2024

(30) Foreign Application Priority Data
Dec. 8, 2023 (JP) 2023-207680

(51) Int. Cl. G02B 6/12

(52) U.S. Cl. CPC G02B 6/12004; G02B 6/12002; G02B 2006/12109; G02B 2006/12123; G02B 2006/12138

(57) ABSTRACT

A detection device includes: a light guide plate; light diffusion structures including first to fourth structures; an optical sensor; and a light source. A first side connecting a first center of the first structure to a second center of the second structure, a second side connecting the first center to a third center of the third structure, and a third side connecting the second center to the third center form a first isosceles triangle with the first side as a base and the second and third sides as equal sides. A fourth side connecting a fourth center of the fourth structure to the second center, a fifth side connecting the fourth center to the third center, and the third side form a second isosceles triangle with the fifth side as a base and the third and fourth sides as equal sides. The first and second isosceles triangles form a parallelogram.

### CROSS-REFERENCE TO RELATED APPLICATION

This application claims the benefit of priority from Japanese Patent Application No. 2023-207680 filed on Dec. 8, 2023, the entire contents of which are incorporated herein by reference.

### BACKGROUND

### 1. Technical Field

What is disclosed herein relates to a detection device.

### 2. Description of the Related Art

Japanese Patent Publication No. 6830593 (JP-B-6830593) discloses a biosensor that includes an optical sensor including a photosensor (photodetection element), a culture vessel placed on the upper side of an imaging surface of the photosensor, and a point light source disposed above the culture vessel. The culture vessel accommodates therein a culture medium and a plurality of objects to be detected (microorganisms). In the biosensor of JP-B-6830593, light emitted from the point light source passes through the culture medium and the objects to be detected (microorganisms), and enters the photodiode. The biosensor of JP-B-6830593 may, however, have difficulty in detecting the objects to be detected if the culture medium in the culture vessel has low light transmittance.

Detection devices with higher accuracy of detection of the objects to be detected are required.

For the foregoing reasons, there is a need for a detection device that improves the accuracy of detection of the objects to be detected.

### SUMMARY

According to an aspect, a detection device includes: a light-transmitting light guide plate; a plurality of light diffusion structures provided on a surface on one side in a first direction of the light guide plate; an optical sensor that is disposed on the one side in the first direction of the light guide plate so as to overlap the light guide plate and includes a plurality of light detection elements arranged in a plane; and a light source that is disposed adjacent to the light guide plate in a second direction intersecting the first direction and is configured to emit light to a side surface of the light guide plate. As viewed in the first direction, the light diffusion structures include a first structure, a second structure adjacent to the first structure, a third structure adjacent to the first structure and the second structure, and a fourth structure adjacent to the second structure and the third structure; the first structure is positioned opposite the fourth structure with respect to a straight line passing through the second structure and the third structure; a first side connecting a first center of the first structure to a second center of the second structure, a second side connecting the first center to a third center of the third structure, and a third side connecting the second center to the third center form a first isosceles triangle that has the first side as a base and the second and third sides as equal sides; a fourth side connecting a fourth center of the fourth structure to the second center, a fifth side connecting the fourth center to the third center, and the third side form a second isosceles triangle that has the fifth side as a base and the third and fourth sides as equal sides; the first isosceles triangle and the second isosceles triangle form a parallelogram having the first center, the second center, the third center, and the fourth center as vertices; in the parallelogram, the first side is parallel to the fifth side, and the second side is parallel to the fourth side; and four interior angles of the parallelogram are an obtuse angle or an acute angle.

### BRIEF DESCRIPTION OF THE DRAWINGS

FIG. 1 is a side view schematically illustrating a detection device according to an embodiment of the present disclosure;

FIG. 2 is a schematic diagram illustrating an arrangement of light diffusion structures according to the embodiment;

FIG. 3 is a schematic diagram illustrating a parallelogram formed by line segments connecting more than one of the light diffusion structures according to the embodiment;

FIG. 4 is a schematic diagram illustrating a first isosceles triangle formed by line segments connecting more than one of the light diffusion structures according to the embodiment;

FIG. 5A is an enlarged schematic diagram of the parallelogram formed by the line segments connecting more than one of the light diffusion structures according to the embodiment;

FIG. 5B is a schematic diagram obtained by adding indications of distances L7, L8, and L9 to FIG. 5A;

FIG. 6 is a schematic diagram illustrating a comparative example with respect to FIG. 5A and is a diagram in which a square is formed by line segments connecting more than one of the light diffusion structures;

FIG. 7A is an enlarged schematic view of a section of a collimator and a light guide plate as one example of an optical filter;

FIG. 7B is an enlarged schematic view of a section of a louver and the light guide plate as one example of the optical filter;

FIG. 8 is a block diagram illustrating a configuration example of the detection device according to the embodiment;

FIG. 9 is a side view schematically illustrating propagation of light in the light guide plate; and

FIG. 10 is a flowchart illustrating a detection operation example of the detection device according to the embodiment.

### DETAILED DESCRIPTION

The following describes a mode (embodiment) for carrying out the present invention in detail with reference to the drawings. The present disclosure is not limited to the description of the embodiment given below. Components described below include those easily conceivable by those skilled in the art or those that are substantially identical thereto. In addition, the components described below can be combined as appropriate. What is disclosed herein is merely an example, and the present disclosure naturally encompasses appropriate modifications easily conceivable by those skilled in the art while maintaining the gist of the present disclosure.

To further clarify the description, the drawings may schematically illustrate, for example, widths, thicknesses, and shapes of various parts as compared with actual aspects thereof. However, they are merely examples, and interpretation of the present disclosure is not limited thereto. The same component as that described with reference to an already mentioned drawing is denoted by the same reference numeral through the present disclosure and the drawings, and detailed description thereof may not be repeated where appropriate.

In XYZ coordinates in the drawings, a Z direction (first direction) corresponds to the up-down direction; an X direction (second direction) corresponds to the right-left direction; and a Y direction corresponds to the front-rear direction. The X direction intersects (at right angles) the Y and Z directions; the Y direction intersects (at right angles) the X and Z directions; and the Z direction intersects (at right angles) the X and Y directions. A Z1 side is one side in the first direction, and a Z2 side is the other side in the first direction. An X1 side is one side in the second direction, and an X2 side is the other side in the second direction.

### Embodiment

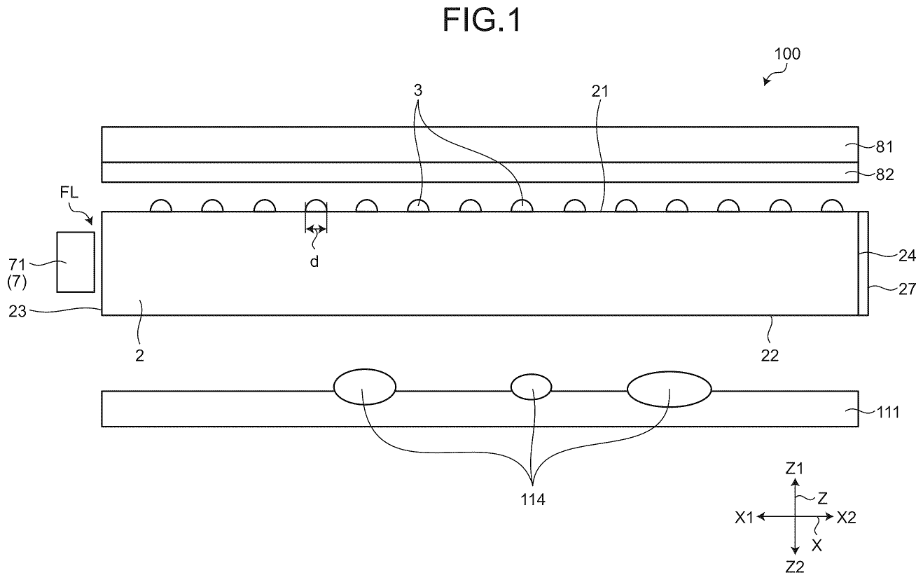

A detection device according to the embodiment will be described. FIG. 1 is a side view schematically illustrating the detection device according to the embodiment.

As illustrated in FIG. 1, a detection device 100 includes an object placement stage 111, a front light FL, an optical sensor 81, and an optical filter 82. The front light FL includes a light guide plate 2, a light source device 7, and a light diffusion structure 3. That is, in other words, the detection device 100 includes the object placement stage 111, the light guide plate 2, the light source device 7, the light diffusion structure 3, the optical sensor 81, and the optical filter 82.

The object placement stage 111 is a container, such as a Petri dish, and a culture medium. An object to be detected 114 is placed on the object placement stage 111. The object to be detected 114 is the culture medium and microorganisms, such as bacteria, generated in the culture medium, or a sample including the microorganisms. The object to be detected 114 is not limited to the bacteria and may be other micro-objects such as cells.

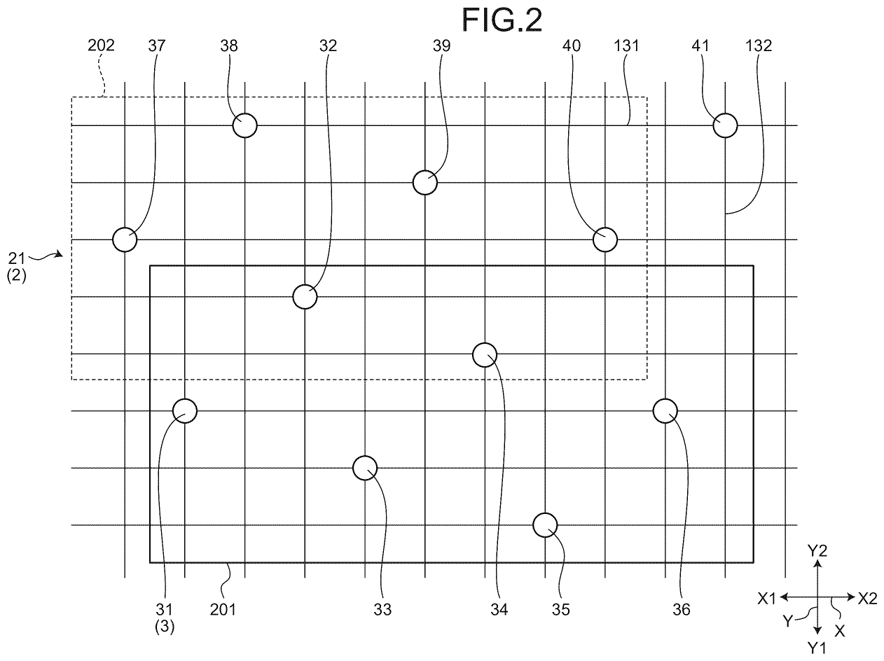

The light guide plate 2 is located so as to overlap the Z1 side (one side in the first direction) of the object placement stage 111. In other words, the object placement stage 111 is disposed on the Z2 side (other side in the first direction) of the light guide plate 2 so as to overlap the light guide plate 2 and has the object to be detected 114 placed thereon. The light guide plate 2 has a light-transmitting property. As illustrated in FIG. 2, the light guide plate 2 is a flat plate member. The light guide plate 2 has a first surface 21, a second surface 22, and side surfaces 23 and 24. The first surface 21 is a principal surface on the Z1 side, and the second surface 22 is a surface on the opposite side (that is, the Z2 side) to the first surface 21. The side surface 23 is located on an X1 side, and the side surface 24 is located on an X2 side.

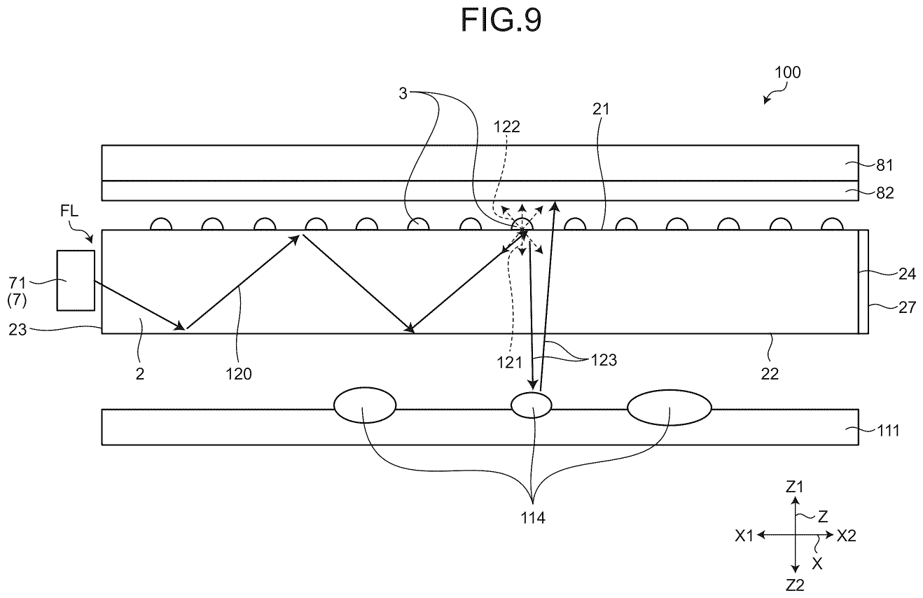

A reflective plate 27 is bonded to the side surface 24 of the light guide plate 2. The reflective plate 27 reflects light 120 propagating in the light guide plate 2 to reduce the light 120 (refer to FIG. 9) leaking from the side surface 24 toward outside the light guide plate 2.

The light source device 7 faces the side surface 23 of the light guide plate 2. The light source device 7 is disposed on the X1 side of the side surface 23 of the light guide plate 2. The light source device 7 emits the light 120 (refer to FIG. 9) to the side surface 23 of the light guide plate 2. The light source device 7 includes a plurality of light sources 71, for example. The light sources 71 are a plurality of light-emitting diodes (LEDS), for example. That is, the light sources 71 are arranged along the Y direction and arranged so as to face the side surface 23 of the light guide plate 2.

As illustrated in FIG. 1, a plurality of the light diffusion structures 3 are provided on the first surface 21 of the light guide plate 2. The light diffusion structures 3 causes the light 120 that has entered the light guide plate 2 to exit toward the Z2 side (object placement stage side). The light diffusion structure 3 is, for example, a scatterer including a protruding scatterer. The protruding scatterer is a hemispherical light-transmitting member that protrudes toward the Z1 side from the first surface 21 of the light guide plate 2. That is, as viewed in the Z direction, the protruding scatterer has a circular shape having a diameter “d”. In the present disclosure, the shape of the light diffusion structure 3 as viewed in the Z direction is not limited to a circular shape, and the examples of the shape include also other shapes such as a polygonal shape. Part of the light 120 propagating in the light guide plate 2 is scattered by the light diffusion structures 3. The light diffusion structure 3 may have a hemispherical recessed shape that is provided on the first surface 21 of the light guide plate 2 and is recessed toward the Z2 side. The arrangement of the light diffusion structures 3 will be described later in detail.

As illustrated in FIG. 1, the optical sensor 81 and the optical filter 82 are arranged in an overlapping manner on the Z1 side of the light guide plate 2. The optical sensor 81 is disposed on the Z1 side of the optical filter 82. That is, the optical filter 82 is disposed between the optical sensor 81 and the light guide plate 2. The optical sensor 81 includes a plurality of photodiodes 813 (light detection elements) arranged in a plane. The optical filter 82 will be described later.

The following describes the arrangement of the light diffusion structures 3 as viewed in the Z direction. FIG. 2 is a schematic diagram illustrating the arrangement of the light diffusion structures according to the embodiment. As illustrated in FIG. 2, as viewed in the Z direction, the light diffusion structures 3 provided on the first surface 21 of the light guide plate 2 include, for example, a first structure 31, a second structure 32, a third structure 33, a fourth structure 34, a fifth structure 35, a sixth structure 36, a seventh structure 37, an eighth structure 38, a ninth structure 39, a tenth structure 40, and an eleventh structure 41. The first structure 31, the second structure 32, the third structure 33, the fourth structure 34, the fifth structure 35, and the sixth structure 36 are arranged in a first area 201 indicated with a solid line. The seventh structure 37, the eighth structure 38, the second structure 32, the ninth structure 39, the fourth structure 34, and the tenth structure 40 are arranged in a second area 202 indicated with a dashed line.

In FIGS. 2 to 6, vertical and horizontal ruled lines are illustrated to facilitate understanding of the arrangement of the light diffusion structures 3.

Specifically, first ruled lines 131 extending in the X direction and second ruled lines 132 extending in the Y direction are illustrated. The first ruled lines 131 are arranged at equal intervals in the Y direction. The second ruled lines 132 are arranged at equal intervals in the X direction. The first ruled lines 131 intersect the second ruled lines 132 to form a plurality of squares in a grid pattern. The light diffusion structures 3 are arranged at intersections where the first ruled lines 131 intersect the second ruled lines 132.

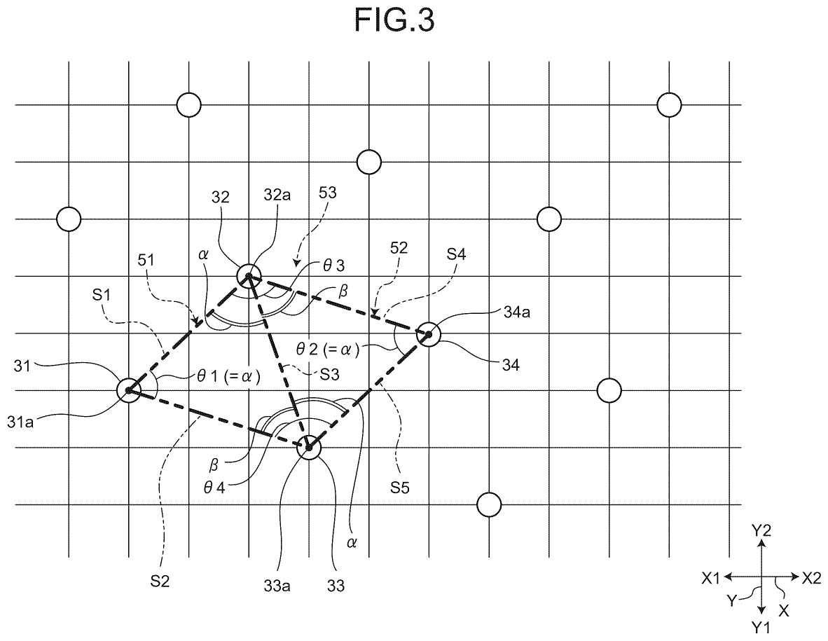

FIG. 3 is a schematic diagram illustrating a parallelogram formed by line segments connecting more than one of the light diffusion structures according to the embodiment. As illustrated in FIG. 3, a parallelogram 53 is formed by line segments connecting a first center 31a of the first structure 31, a second center 32a of the second structure 32, a third center 33a of the third structure 33, and a fourth center 34a of the fourth structure 34. The parallelogram 53 is formed by combining a first isosceles triangle 51 with a second isosceles triangle 52. A detailed description will be made below.

The second structure 32 is adjacent to the first structure 31. The third structure 33 is adjacent to the first and the second structures 31 and 32. The fourth structure 34 is adjacent to the second and the third structures 32 and 33. The first structure 31 is located opposite the fourth structure 34 with respect to a straight line passing through the second center 32a and the third center 33a.

The first isosceles triangle 51 is formed by a first side S1, a second side S2, and a third side S3. The first side S1 is a line segment connecting the first center 31a to the second center 32a. The second side S2 is a line segment connecting the first center 31a to the third center 33a. The third side S3 is a line segment connecting the second center 32a to the third center 33a. The base in the first isosceles triangle 51 is the first side S1. The equal sides in the first isosceles triangle 51 are the second side S2 and the third side S3. Therefore, the length of the second side S2 is equal to the length of the third side S3.

The second isosceles triangle 52 is formed by a fourth side S4, a fifth side S5, and the third side S3. The fourth side S4 is a line segment connecting the fourth center 34a to the second center 32a. The fifth side S5 is a line segment connecting the fourth center 34a to the third center 33a. The base in the second isosceles triangle 52 is the fifth side S5. The equal sides in the second isosceles triangle 52 are the fourth side S4 and the third side S3. Therefore, the length of the fourth side S4 is equal to the length of the third side S3.

Thus, by combining the first isosceles triangle 51 with the second isosceles triangle 52, the parallelogram 53 having vertices at the first center 31a, the second center 32a, the third center 33a, and the fourth center 34a is formed.

Four interior angles θ1, θ2, θ3, and θ4 of the parallelogram 53 are each an obtuse angle or an acute angle. In detail, the interior angle θ1 is an angle formed between the first side S1 and the second side S2. The interior angle θ2 is an angle formed between the fourth side S4 and the fifth side S5. The interior angle θ2 is the opposite angle to the interior angle θ1. The interior angle θ3 is an angle formed between the first side S1 and the fourth side S4. The interior angle θ4 is an angle formed between the second side S2 and the fifth side S5. The interior angle θ4 is the opposite angle to the interior angle θ3. Consequently, the interior angle θ2 is equal to the interior angle θ1, and the interior angle θ4 is equal to the interior angle θ3. In the embodiment, the interior angles θ2 and 01 are acute angles, and the interior angles θ4 and θ3 are obtuse angles. In the parallelogram 53, the first side S1 is parallel to the fifth side S5 and the second side S2 is parallel to the fourth side S4. The parallelogram is not limited to the parallelogram 53, and can be variously formed by line segments connecting the centers of adjacent four of the light diffusion structures 3. For example, in the first area 201, a parallelogram is formed by line segments connecting the centers of the third structure 33, the fourth structure 34, the fifth structure 35, and the sixth structures 36. In the second area 202, a parallelogram is formed by line segments connecting the centers of the seventh structure 37, the eighth structure 38, the second structure 32, and the ninth structure 39, and a parallelogram is also formed by line segments connecting the centers of the second structure 32, the ninth structure 39, the fourth structure 34 and the tenth structure 40.

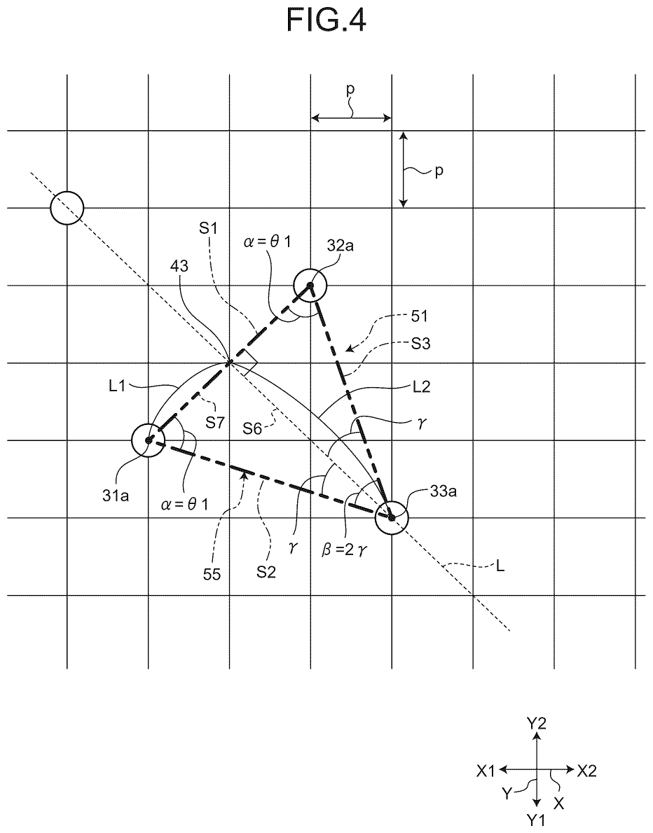

FIG. 4 is a schematic diagram illustrating the first isosceles triangle formed by line segments connecting more than one of the light diffusion structures according to the embodiment. As described above, the first isosceles triangle 51 is formed by the first side S1, the second side S2, and the third side S3, and the length of the second side S2 is equal to the length of the third side S3.

When an angle β is the vertex angle and an angle α is the base angle in the first isosceles triangle 51, the angle β is an angle formed between the second side S2 and the third side S3, and the angle α is an angle formed between the first side S1 and the second side S2 or an angle formed between the first side S1 and the third side $3.

When a midpoint 43 is the midpoint of the first side S1, a line L passing through the third center 33a and the midpoint 43 is a perpendicular bisector of the first side S1. Therefore, when a sixth side S6 is a line segment connecting the third center 33a to the midpoint 43 and a seventh side S7 is a line segment connecting the first center 31a to the midpoint 43, the second side S2, the sixth side S6, and the seventh side S7 form a right triangle 55. In the right triangle 55, the sixth side S6 and the seventh side S7 form an angle of 90 degrees. The second side S2 and the seventh side S7 form the angle α, and the second side S2 and the sixth side S6 form an angle Y. As indicated in FIG. 3, the angle α is equal to the interior angle θ1.

When the length of the seventh side S7 is a length L1 and the length of the sixth side S6 is a length L2, then tan α=tan θ1=L2/L1. When a length p is the length of one side of a square in the grid pattern, then L1=√2p and L2=2√2p. As a result, tan θ1=L2/L1=2√2p/√2p=2. Since the interior angle θ1 is equal to the interior angle θ2, the interior angle θ1=interior angle θ2=angle α=arctan (2). The value of arctan (2) is 63.4 degrees as an approximate value obtained by rounding off the second decimal place. Therefore, the interior angles θ1 and θ2 are acute angles.

The angle γ satisfies tan γ=L1/L2=√2p/2√2p=0.5. That is, the angle γ=arctan (0.5), and the angle β formed between the second side S2 and the third side S3 is twice the angle γ, so that the angle β=2×angle γ=2 arctan (0.5). The value of 2 arctan (0.5) is 53.1 degrees as an approximate value obtained by rounding off the second decimal place.

Referring to FIG. 3, the interior angles θ3 and θ4 are each the sum of the angles β and α. Therefore, the interior angle θ3=interior angle θ4=angle β+angle α=2 arctan (0.5)+arctan (2). The value of “2 arctan (0.5)+arctan (2)” is 116.5 degrees as an approximate value obtained by rounding off the second decimal place. Therefore, the interior angles θ3 and θ4 are obtuse angles.

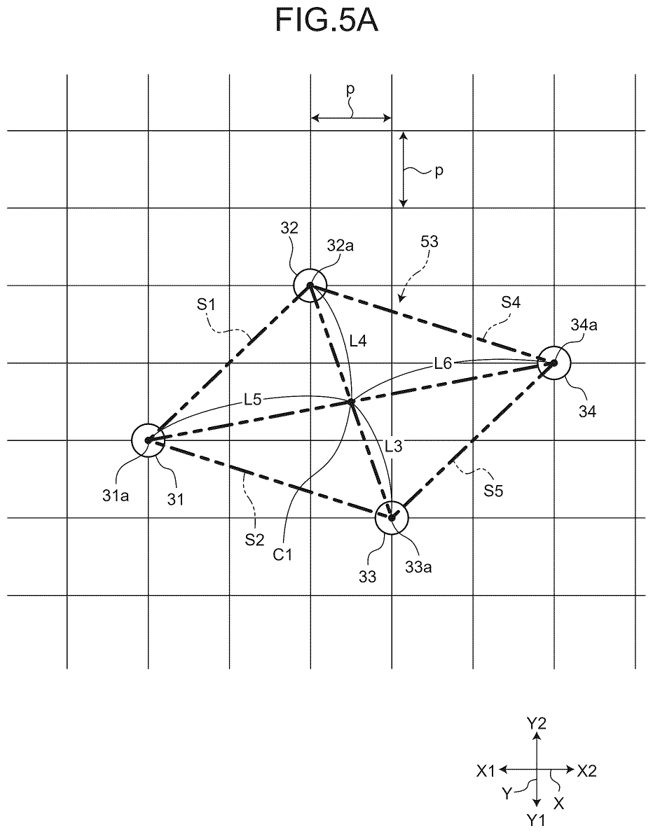

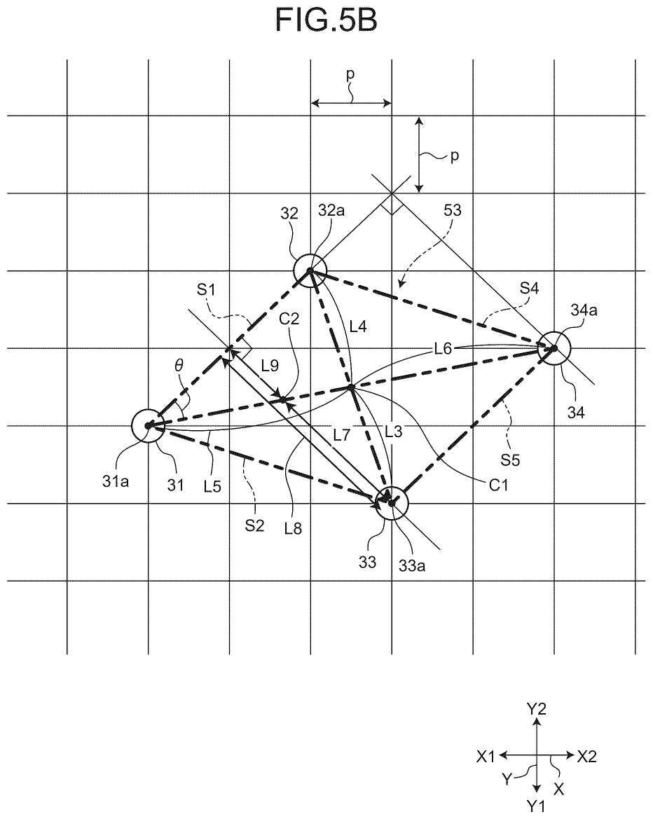

Then, for the adjacent four of the light diffusion structures 3, the average of distances between the light diffusion structures 3 and the center thereof is obtained. Scattered light 121 diffused from the light diffusion structure 3 radially spreads with respect to the light diffusion structure 3 as the center, so that the amount of the scattered light 121 decreases with a distance from the light diffusion structure 3. Therefore, as for the total light intensity of the scattered light 121 diffused from the adjacent four of the light diffusion structures 3, the amount of the scattered light 121 is smallest at the intersection of the diagonals of the quadrilateral having the four light diffusion structures 3 as the vertices. Therefore, at the intersection of the diagonals, the smaller the average of the distances from the vertices of the quadrilateral to the intersection of the diagonals, the larger the total amount of the scattered light 121 diffused from the four light diffusion structures 3. FIG. 5A is an enlarged schematic diagram of the parallelogram 53 formed by the line segments connecting more than one of the light diffusion structures according to the embodiment. Thus, specifically, the average of the distances from the vertices of the parallelogram 53 to the intersection of the diagonals is obtained. A detailed description will be made below.

As illustrated in FIG. 5A, the vertices of the parallelogram 53 are the first center 31a, the second center 32a, the third center 33a, and the fourth center 34a. The intersection of the two diagonals is a center C1. The distance between the center C1 and the third center 33a is a distance L3; the distance between the center C1 and the second center 32a is a distance L4; the distance between the center C1 and the first center 31a is a distance L5; and the distance between the center C1 and the fourth center 34a is a distance L6. In this case, the average of the distances from the vertices of the parallelogram 53 to the center C1 is the average of the distances L3, L4, L5, and L6.

By the geometric characteristics of the parallelogram 53, distance L3=distance L4. Since distance L3+distance L4=√10p, distance L3=distance L4=√10p/2. By the geometric characteristics of the parallelogram 53, distance L5=distance L6. Since distance L5+distance L6=√26p, distance L5=distance L6=√26p/2. Therefore, the average of the distances L3, L4, L5, and L6 is (√10p+√26p)/4. The approximate value obtained by rounding off the second decimal place of (√10p+√26p)/4 is 8.3p. Therefore, the average of the distances from the vertices of the parallelogram 53 to the intersection of the diagonals is 2.1p as an approximate value obtained by rounding off the second decimal place.

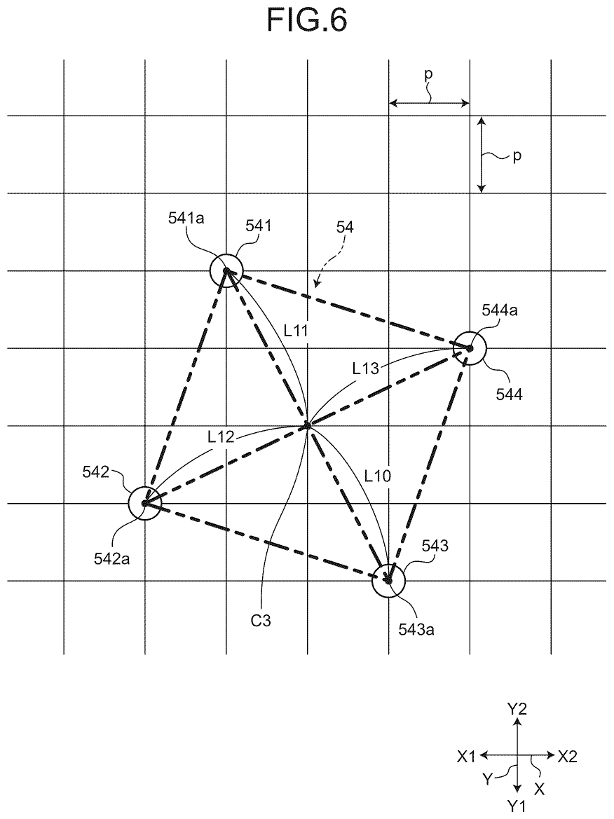

The following describes a comparative example with respect to FIG. 5A, with reference to FIG. 6. FIG. 6 is a schematic diagram illustrating the comparative example with respect to FIG. 5A and is a diagram in which a square is formed by line segments connecting multiple light diffusion structures.

A square 54 illustrated in FIG. 6 is formed by line segments connecting a center 541a of a structure 541, a center 542a of a structure 542, a center 543a of a structure 543, and a center 544a of a structure 544. The structure 541 corresponds to the second structure 32 illustrated in FIG. 5A, and the structure 544 corresponds to the fourth structure 34 illustrated in FIG. 5A. The intersection of the two diagonals in the square 54 is a center C3. The distance between the center C3 and the center 543a is a distance L10; the distance between the center C3 and the center 541a is a distance L11; the distance between the center C3 and the center 542a is a distance L12; and the distance between the center C3 and the center 544a is a distance L13.

By the geometric characteristics of the square, the distances L10, L11, L12, and L13 are all equal. The distance L10=√5p. The approximate value obtained by rounding off the second decimal place of √5p is 2.2p. Therefore, the average of the distances from the vertices of the square 54 to the intersection of the diagonals is 2.2p as an approximate value obtained by rounding off the second decimal place.

In summary, the average of the distances from the vertices of the parallelogram 53 according to the present embodiment to the intersection of the diagonals calculated with reference to FIG. 5A is 2.1p as the approximate value obtained by rounding off the second decimal place. In contrast, the average of the distances from the vertices of the square 54 to the intersection of the diagonals according to the comparative example calculated with reference to FIG. 6 is 2.2p as the approximate value obtained by rounding off the second decimal place. Therefore, it is confirmed that the average of the distances from the center to the light diffusion structures is smaller in the present embodiment than in the comparative example.

To facilitate the design of the arrangement of the light diffusion structures, each of the light diffusion structures is disposed at an intersection of the respective straight lines forming the grid. In this case, the three adjacent light diffusion structures 3 preferably form a shape as similar as possible to an equilateral triangle. For example, a triangle obtained by connecting the first center 31a, the second center 32a, and the third center 33a and a triangle obtained by connecting the second center 32a, the third center 33a, and the fourth center 34a are preferably as similar as possible to that of an equilateral triangle.

In the case of an equilateral triangle, when d denotes the length of each side, the distance from a location of a point farthest from each vertex to the vertex is (2/d)/{cos(30°)}=0.58d. When d denotes the length of one side of a square, the distance from a location farthest from each vertex of the square to the vertex is (2/d)/{cos(45°)}≈0.7d.

Consider a triangle connecting the center 541a, the center 542a, and the center 543a in FIG. 6. A point farthest from the center 541a, the center 542a, and the center 543a that are the vertices of this isosceles right triangle is the center C3, and the distances from the center C3 to the center 541a, the center 542a, and the center 543a are each substantially 2.2p.

Consider also the triangle connecting the first center 31a, the second center 32a, and the third center 33a in FIG. 5A. The length of the first side S1 is 2p√2≈2.83p. In the case of an equilateral triangle having a length of one side of 2.83p, the distance from a point farthest from each vertex to the vertex is approximately 2.83p×0.58=1.64p. The triangle connecting the first center 31a, the second center 32a, and the third center 33a is not an equilateral triangle, but all interior angles are smaller than 90°. Since this triangle has a shape similar to an equilateral triangle, the distance from a point farthest from the first center 31a, the second center 32a, and the third center 33a to each vertex is closer to 1.64p than to 2.2p. FIG. 5B is a schematic diagram obtained by adding indications of distances L7, L8, and L9 to FIG. 5A. For example, in FIG. 5B, the distance from the point farthest from the first center 31a, the second center 32a, and the third center 33a to each vertex is smaller than a distance L7 from the third center 33a to the center C2. The distance L7=distance L8−distance L9=2√2p−distance L9. The distance L9=√2p×tan θ. Also, θ=arctan (2√2p/3√2p)=arctan (⅔)≈33.69 degrees. Therefore, the distance L7=2√2p−√2p×tan θ≈1.89p. That is, the distance from the scattering structure point to the farthest point according to the embodiment is equal to or smaller than 1.89p. Thus, among the distances from the first center 31a, the second center 32a, and the third center 33a to the center C2, the farthest distance L7 is 1.89p, and therefore, the distances are each smaller than 2.2p.

It can be understood from the above that the arrangement of the light diffusion structures in FIGS. 5A and 5B can scatter light more evenly than the arrangement in FIG. 6.

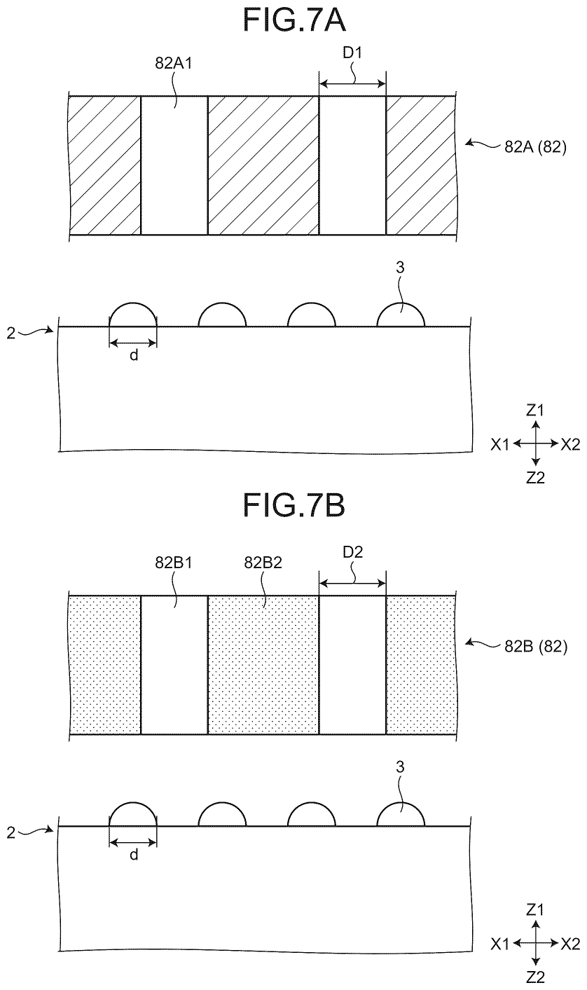

The following describes the optical filter 82. FIG. 7A is an enlarged schematic view of a section of a collimator and the light guide plate as one example of the optical filter. FIG. 7B is an enlarged schematic view of a section of a louver and the light guide plate as one example of the optical filter.

The optical filter 82 is an optical element that transmits, toward the optical sensor 81, components of the light 120 reflected by the object to be detected 114 and traveling in the Z direction. The optical filter 82 includes light-blocking portions and light guide portions. The light-blocking portions have higher light absorbance than the light guide portions. Examples of the optical filter 82 include, but are not limited to, a collimator 82A (collimating apertures) illustrated in FIG. 7A and a louver 82B illustrated in FIG. 7B.

As illustrated in FIG. 7A, the collimator 82A has therein cylindrical holes 82A1 (light guide portions) extending along the Z direction. The holes 82A1 transmit, toward the optical sensor 81, the light 120 reflected by the object to be detected 114. A diameter D1 (maximum distance along the X direction in the section) of each of the holes 82A1 is larger than the diameter “d” of the light diffusion structure 3.

As illustrated in FIG. 7B, the louver 82B includes plate-like light-blocking portions 82B2 and light guide portions 82B1. The light-blocking portions 82B2 and the light guide portions 82B1 extend in the Z direction. The light-blocking portions 82B2 and the light guide portions 82B1 are alternately arranged along the X direction. The light-blocking portions 82B2 have higher light absorbance than the light guide portions 82B1. The light guide portions 82B1 transmit, toward the optical sensor 81, the light 120 reflected by the object to be detected 114. A width D2, which is in the X direction (maximum distance in the X direction in the section), of each of the light guide portions 82B1 is larger than the diameter “d” of the light diffusion structure 3.

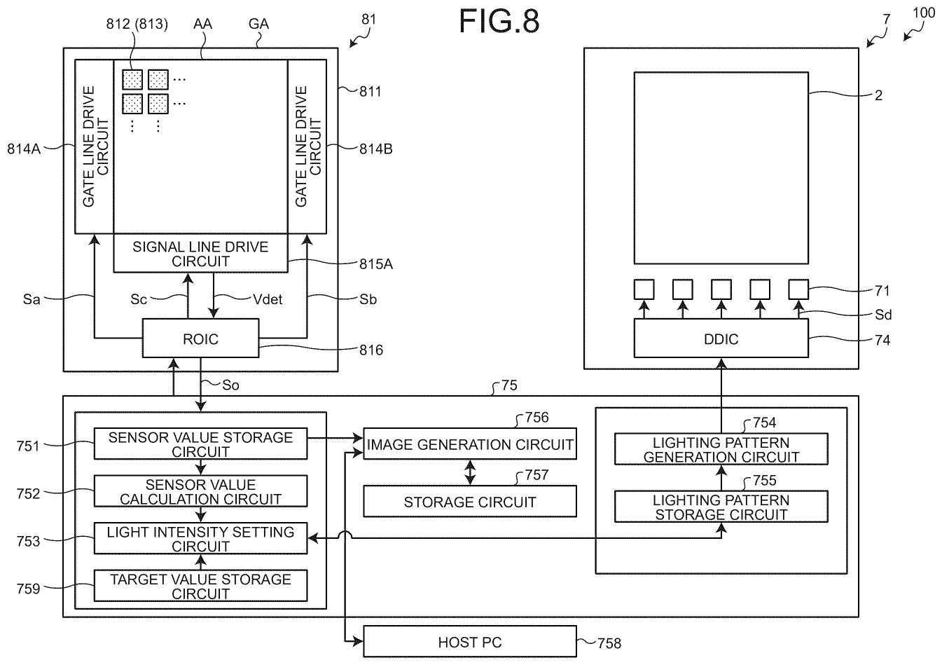

FIG. 8 is a block diagram illustrating a configuration example of the detection device according to the embodiment. As illustrated in FIG. 8, the detection device 100 includes the optical sensor 81, the light source device 7, and a host integrated circuit (IC) 75 that controls the light source device 7. The optical sensor 81 includes an array substrate 811, a plurality of sensor pixels 812 (photodiodes 813) formed on the array substrate 811, gate line drive circuits 814A and 814B, a signal line drive circuit 815A, and a detection control circuit (ROIC) 816. Thus, the optical sensor 81 includes the photodiodes 813.

The array substrate 811 is formed using a substrate as a base. Each of the sensor pixels 812 is configured with a corresponding one of the photodiodes 813, a plurality of transistors, and various types of wiring.

The array substrate 811 has a detection area AA and a peripheral area GA. The detection area AA is an area provided with the sensor pixels 812 (photodiodes 813). The peripheral area GA is an area between the outer perimeter of the detection area AA and the outer edges of the array substrate 811, and is an area not provided with the sensor pixels 812. The gate line drive circuits 814A and 814B, the signal line drive circuit 815A, and the detection control circuit 816 are provided in the peripheral area GA.

Each of the sensor pixels 812 is an optical sensor that includes the photodiode 813 as a sensor element. Each of the photodiodes 813 outputs an electrical signal corresponding to light emitted thereto.

The detection control circuit 816 is a circuit that supplies control signals Sa, Sb, and Sc to the gate line drive circuits 814A and 814B and the signal line drive circuit 815A, respectively, to control operations of these circuits. The detection control circuit 816 includes a signal processing circuit that processes a detection signal Vdet from each of the photodiodes 813.

The detection control circuit 816 processes the detection signals Vdet from the photodiodes 813, and outputs sensor values So based on the detection signals Vdet to the host IC 75. Through this operation, the detection device 100 detects information on the object to be detected 114.

The light source device 7 includes the light sources 71 and a light-emitting element control circuit (DDIC) 74. As described above, the light sources 71 are disposed so as to face the side surface 23 of the light guide plate 2. The light sources 71 are driven to be switched between on (lit state) and off (unlit state) by a command Sd of the light-emitting element control circuit 74.

The host IC 75 includes, as a control circuit for the optical sensor 81, a sensor value storage circuit 751, a sensor value calculation circuit 752, a light intensity setting circuit 753, a target value storage circuit 759, a storage circuit 757, and a host personal computer (PC) 758. The sensor value storage circuit 751 stores therein the sensor values So output from the detection control circuit 816 of the optical sensor 81. The sensor value calculation circuit 752 performs a predetermined calculation process on the sensor values So of the photodiodes 813.

In a light intensity setting mode, the light intensity setting circuit 753 compares the sensor values So detected by the photodiodes 813 with a preset target sensor value So-t acquired from the target value storage circuit 759 to set light intensities of the light sources 71 for detection. The target value storage circuit 759 stores therein the preset target sensor value So-t.

The host IC 75 includes, as a control circuit for the light source device 7, a lighting pattern generation circuit 754 and a lighting pattern storage circuit 755. The lighting pattern storage circuit 755 stores therein information on the light intensity of each of the light sources 71 in the light intensity setting mode.

The lighting pattern generation circuit 754 generates various control signals based on the information on the light intensity in the lighting pattern storage circuit 755.

In a detection mode, an image generation circuit 756 generates an image of the object to be detected 114 based on the sensor values So output from the photodiodes 813.

The host IC 75 further includes the storage circuit 757. The storage circuit 757 stores therein base image data obtained by detecting, by the optical sensor 81, the light emitted from the light sources 71 when the object to be detected 114 is not placed on the object placement stage 111. The base image data may indicate substantially the same reflectance as that of the object placement stage on which nothing is placed. That is, the base image data may be obtained by, for example, placing a subject having uniform reflectance within a detection surface (such as a black board or a white board) and detecting the subject. The host PC 758 is coupled to the image generation circuit 756. The host PC 758, for example, stores the image data received from the image generation circuit 756 and also stores difference image data obtained by subtracting the base image data from the captured image data.

The following describes the propagation of the light. FIG. 9 is a side view schematically illustrating the propagation of the light in the light guide plate. As illustrated in FIG. 9, the light 120 emitted from the light sources 71 enters the inside of the light guide plate 2 from the side surface 23 of the light guide plate 2, and propagates in the light guide plate 2 while being repeatedly totally reflected on the first surface 21 and the second surface 22. Part of the light 120 propagating in the light guide plate 2 is scattered by the light diffusion structure 3 and becomes the scattered light 121. Light 123 as part of the scattered light 121 is output from the second surface 22 of the light guide plate 2 to the object to be detected 114 and then reflected by the object to be detected 114. The reflected light is transmitted through the light guide plate 2 and the optical filter 82 and output to the photodiodes 813 of the optical sensor 81. The scattered light 121 scattered by the light diffusion structure 3 includes also light 122 that is output to the optical filter 82 facing the light guide plate 2, in addition to the light 123 that is output toward the object to be detected 114.

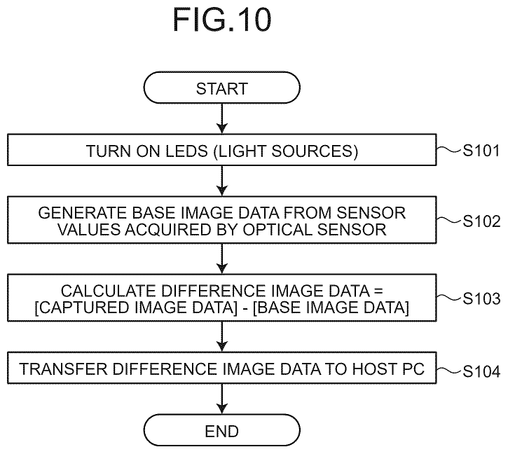

The following describes a detection operation example of the detection device with reference to FIG. 10 and other drawings. FIG. 10 is a flowchart illustrating the detection operation example of the detection device according to the embodiment.

First, the light source device 7 turns on the light sources 71 based on a control signal from the lighting pattern generation circuit 754 (refer to FIG. 8) (Step S101).

Then, when the object to be detected 114 is not placed on the object placement stage 111, the base image data obtained by detecting the light emitted from the light sources 71 using the optical sensor 81 is generated (Step S102). The base image data is stored in the storage circuit 757 (refer to FIG. 8).

The difference image data is then calculated (Step S103). The difference image data is data obtained by subtracting the base image data from the captured image data. Specifically, when the object to be detected 114 is placed on the object placement stage 111, the captured image data obtained by the detection using the optical sensor 81 is acquired, and then, based on the difference between the base image data and the captured image data, the difference image data indicating the detection result when the object to be detected 114 is placed on the object placement stage 111 is obtained. The difference image data is calculated by the image generation circuit 756 (refer to FIG. 8). The difference image data is then transferred to the host PC 758 and stored in the host PC 758 (Step S104).

As described above, the detection device 100 according to the embodiment includes the light guide plate 2, the light diffusion structures 3, the optical sensor 81 including the photodiodes 813 (light detection elements) arranged in a plane, and the light sources 71. As viewed in the Z direction, the light diffusion structures 3 include the first structure 31, the second structure 32, the third structure 33, and the fourth structure 34. The first isosceles triangle 51 is formed by the first side S1, the second side S2, and the third side S3. The second isosceles triangle 52 is formed by the fourth side S4, the fifth side S5, and the third side S3. The parallelogram 53 having the vertices at the first center 31a, the second center 32a, the third center 33a, and the fourth center 34a is formed. In the parallelogram 53, the first side S1 is parallel to the fifth side S5, and the second side S2 is parallel to the fourth side S4. The four interior angles of the parallelogram 53 are an obtuse angle or an acute angle.

As described above, since the biosensor of JP-B-6830593 may have difficulty in detecting the objects to be detected (microorganisms) if the culture medium in the culture vessel has low light transmittance, detection devices with higher accuracy of detection of the object to be detected are required.

In the detection device 100, the light sources 71 are provided on the lateral side of the light guide plate 2; the light diffusion structures 3 are provided on the first surface 21 of the light guide plate 2; and the light diffusion structures 3 are arranged so as to be located at the vertices of the parallelogram 53.

As described above, as for the total light intensity of the scattered light 121 diffused from the adjacent four of the light diffusion structures 3, the amount of the scattered light 121 is smallest at the intersection of the diagonals of the quadrilateral having the four light diffusion structures 3 as the vertices. Therefore, at the intersection of the diagonals, the smaller the average of the distances from the vertices of the quadrilateral to the intersection of the diagonals, the larger the total amount of the scattered light 121 diffused from the four light diffusion structures 3.

As verified with reference to FIG. 5A, the average of the distances from the vertices of the parallelogram 53 according to the present embodiment to the intersection of the diagonals (center C1) is 2.1p. When the square 54 is used as the comparative example of the arrangement configuration of the light diffusion structures 3 in contrast to the parallelogram 53 of the detection device 100 of the present embodiment, the average of the distances from the vertices of the square 54 to the intersection of the diagonals (center C3) is 2.2p, as verified with reference to FIG. 6. Thus, the average of the distances from the vertices of the quadrilateral to the intersection of the diagonals is smaller in the parallelogram 53 according to the present embodiment than in the square 54.

As described with reference to FIG. 5B, among the distances from the first center 31a, the second center 32a, and the third center 33a to the center C2, the farthest distance L7 is 1.89p, and therefore, the distances are each smaller than 2.2p.

From the above, according to the present embodiment, the total amount of the scattered light 121 diffused from the light diffusion structures 3 is larger. Therefore, the detection device that improves the accuracy of detection of the objects to be detected can be provided.

In the parallelogram 53, the interior angles θ1 and θ2 are each arctan (2), and the interior angles θ3 and θ4 are each the sum of 2 arctan (0.5) and arctan (2).

The interior angles θ1 and θ2 are each approximately 63.4 degrees, and are, therefore, acute angles. The interior angles θ3 and θ4 are each approximately 116.5 degrees, and are, therefore, obtuse angles. Therefore, a quadrilateral formed by line segments connecting the first structure 31, the second structure 32, the third structure 33, and the fourth structure 34 is neither a square nor a rectangle, but a parallelogram. Thus, as described above, the average of the distances from the vertices of the quadrilateral to the intersection of the diagonals is smaller, and the total amount of the scattered light 121 diffused from the adjacent four of the light diffusion structures 3 is larger.

The optical filter 82 is provided between the light guide plate 2 and the optical sensor 81. The optical filter 82 causes a larger amount of the light 120 reflected by the object to be detected 114 and transmitted through the light guide plate 2 to travel toward the photodiodes 813. As a result, the accuracy of detection of the object to be detected 114 can further increase.

The object placement stage 111 is provided that is placed on the Z2 side of the light guide plate 2 so as to overlap the light guide plate 2 and is capable of having the object to be detected 114 placed thereon. Therefore, when the object to be detected 114 is, for example, microorganisms such as bacteria or a sample including the microorganisms, the operation of detecting the object to be detected 114 can be performed more smoothly by using a container such as a Petri dish and a culture medium as the object placement stage 111.

Since the optical sensor 81 includes the photodiodes 813, the display quality of the captured image can be made higher.

What is claimed is:

1. A detection device comprising:
a light-transmitting light guide plate;
a plurality of light diffusion structures provided on a surface on one side in a first direction of the light guide plate;
an optical sensor that is disposed on the one side in the first direction of the light guide plate so as to overlap the light guide plate and comprises a plurality of light detection elements arranged in a plane; and
a light source that is disposed adjacent to the light guide plate in a second direction intersecting the first direction and is configured to emit light to a side surface of the light guide plate, wherein
as viewed in the first direction,
the light diffusion structures comprise a first structure, a second structure adjacent to the first structure, a third structure adjacent to the first structure and the second structure, and a fourth structure adjacent to the second structure and the third structure;
the first structure is positioned opposite the fourth structure with respect to a straight line passing through the second structure and the third structure;
a first side connecting a first center of the first structure to a second center of the second structure, a second side connecting the first center to a third center of the third structure, and a third side connecting the second center to the third center form a first isosceles triangle that has the first side as a base and the second and third sides as equal sides;
a fourth side connecting a fourth center of the fourth structure to the second center, a fifth side connecting the fourth center to the third center, and the third side form a second isosceles triangle that has the fifth side as a base and the third and fourth sides as equal sides;
the first isosceles triangle and the second isosceles triangle form a parallelogram having the first center, the second center, the third center, and the fourth center as vertices;
in the parallelogram, the first side is parallel to the fifth side, and the second side is parallel to the fourth side; and
four interior angles of the parallelogram are an obtuse angle or an acute angle.

2. The detection device according to claim 1, wherein
the four interior angles in the parallelogram are an interior angle θ1, an interior angle θ2 that is an angle positioned opposite the interior angle θ1, an interior angle θ3, and an interior angle θ4 that is an angle positioned opposite the interior angle θ3,
the interior angle θ1 is an angle formed between the first side and the second side,
the interior angle θ2 is an angle formed between the fourth side and the fifth side,
the interior angle θ3 is an angle formed between the first side and the fourth side,
the interior angle θ4 is an angle formed between the second side and the fifth side,
the interior angle θ1 and the interior angle θ2 are each arctan (2), and
the interior angle θ3 and the interior angle θ4 are each a sum of 2 arctan (0.5) and arctan (2).

3. The detection device according to claim 1, wherein an optical filter is provided between the light guide plate and the optical sensor.

4. The detection device according to claim 3, comprising an object placement stage that is configured to be placed on the other side in the first direction of the light guide plate so as to overlap the light guide plate and is configured to has an object to be detected placed thereon.

5. The detection device according to claim 1, wherein the optical sensor comprises a plurality of photodiodes.
